(19) United States
(12) Patent Application Publication
(10) Pub. No.: US 2008/0307369 A1
(43) Pub. Date: Dec. 11, 2008

(54) METHOD, INTERACTION METHOD AND APPARATUS FOR VISUALIZING HIERARCHY DATA WITH ANGULAR CHART

(75) Inventors: Shi Xia Liu, Beijing (CN); Xing Hua Lou, Heidelberg (DE); Hui Su, Beijing (CN); Honesty Cheng Young, Saratoga, CA (US)

Correspondence Address: Anne Vachon Dougherty, 3173 Cedar Road, Yorktown Hts., NY, 10598, US

(73) Assignee: International Business Machines Corporation, Armonk, NY (US)

(21) Appl. No.: 12/044,232

(22) Filed: Mar. 7, 2008

(30) Foreign Application Priority Data
Mar. 7, 2007 (CN) 200710086200.3

(51) Int. Cl. G06F 3/048

(52) U.S. Cl. 715/855

(57) ABSTRACT

A method and apparatus for visualizing hierarchy data with angular chart are provided wherein the hierarchy data comprises a plurality of levels. The method comprises determining at least one of the plurality levels of the hierarchy data as base levels; visualizing data units in the base levels with the angular chart, wherein each slice of the angular chart corresponds to the data unit in the hierarchy data; and in response to user's operation on the slice of the angular chart, visualizing data units in at least next level of the data unit corresponding to the selected slice. The data units in each level of the hierarchy data can be visualized hierarchically and clearly, even if the hierarchy data has numerous levels and/or data units.

### TECHNICAL FIELD OF THE INVENTION

The present invention relates to graphic visualization techniques in the computer field, and particularly relates to a method and apparatus for visualizing hierarchy data with an angular chart, and an interaction method and apparatus for angular chart visualization.

### BACKGROUND OF THE INVENTION

Generally, data visualization processing can be implemented by using various views, such as tree diagrams, angular charts, histograms, etc.

An angular chart is a circular or arc graph which is divided into sectors (slices) by radius, such as a pie chart, ring chart, sunburst chart, etc. Usually the angular chart is used to represent distribution of data quantity, such as a regional sales report, campaign approval rating or national population distribution. In the angular chart, each slice corresponds to a data unit, and the central angle thereof is proportional to the data quantity the slice represents. In addition, the angular chart can be extended to visualization of complex hierarchy data, such as a company organization structure, family ancestry, file system, etc.

FIG. 1 shows an angular chart in the form of a sunburst which displays a file system. The angular chart shows clearly the hierarchy of the file system and the context of the respective files. In comparison with other views, therefore, the angular chart always keeps the overview of the hierarchy data and the context in terms of its quantity.

As an example, the hierarchy data may be a company organization structure. FIG. 2 and FIG. 3 respectively illustrate a tree diagram and an angular chart (sunburst chart) which display the organization structure. In FIG. 3, each slice of the angular chart represents an employee, and the central angle is proportional to the number of people (including the employee) he manages. Comparing FIG. 2 with FIG. 3, it is apparent that the tree diagram can not help users to easily have a direct sense of department size of the company.

At present, when the angular chart is used to visualize the hierarchy data, all data units in the hierarchy data are usually displayed together. Thus, there are two problems when using the angular chart to visualize the hierarchy data: firstly, if the hierarchy data has more levels or more data units, the corresponding slices of the angular chart would become small and the peripheral slices tend to be very difficult to distinguish from each other; secondly, since the whole hierarchy data is displayed, the user can not have efficient interaction method to customize the view. Therefore, when the hierarchy data is complex, the angular chart may look tousled and the user can not clearly obtain the desired content.

### SUMMARY OF THE INVENTION

The present invention is provided based on the above-mentioned technical problems and its purpose is to provide a method and apparatus for visualizing hierarchy data with an angular chart and an interaction method and apparatus for angular chart visualization, which can visualize data units in each level of the hierarchy data hierarchically and clearly and can provide an interactive way for a user to customize the desired views.

According to the first aspect of the present invention, a method for visualizing hierarchy data with angular chart is provided, with the hierarchy data comprising a plurality of levels. The method comprises: determining at least one of the plurality of levels of the hierarchy data as base levels; visualizing data units in the base levels with the angular chart, wherein each slice of the angular chart corresponds to the data unit in the hierarchy data; and in response to user's operation on, or selection of, the slice of the angular chart, visualizing data units in at least the next level of the data unit corresponding to the selected slice in the hierarchy data.

According to the second aspect of the present invention, an apparatus is provided for visualizing hierarchy data with an angular chart, the hierarchy data comprising a plurality of levels, which apparatus comprises: a base level determination unit for determining at least one of the plurality of levels of the hierarchy data as base levels; a base level visualization unit for visualizing data units in the base levels with the angular chart, wherein each slice of the angular chart corresponds to the data unit in the hierarchy data; and a response visualization unit for, in response to user's operation on the slice of the angular chart, visualizing data units in at least next level of the data unit corresponding to the selected slice in the hierarchy data.

According to the third aspect of the present invention, an interaction method is provided for angular chart visualization, wherein the angular chart displays hierarchy data comprising a plurality of levels and each slice of the angular chart corresponds to a data unit in the hierarchy data, which method comprises: in response to user's operation on the slice of the angular chart, changing radius and/or central angle of at least one slice associated with the user's operation.

According to the fourth aspect of the present invention, an interaction apparatus is provided for angular chart visualization, wherein the angular chart displays hierarchy data comprising a plurality of levels and each slice of the angular chart corresponds to a data unit in the hierarchy data, which apparatus comprises: a slice adjustment unit for, in response to user's operation on the slice of the angular chart, changing radius and/or central angle of at least one slice associated with the user's operation.

### DESCRIPTION OF THE DRAWINGS

FIG. 1 is a conventional sunburst chart for visualizing a file system.

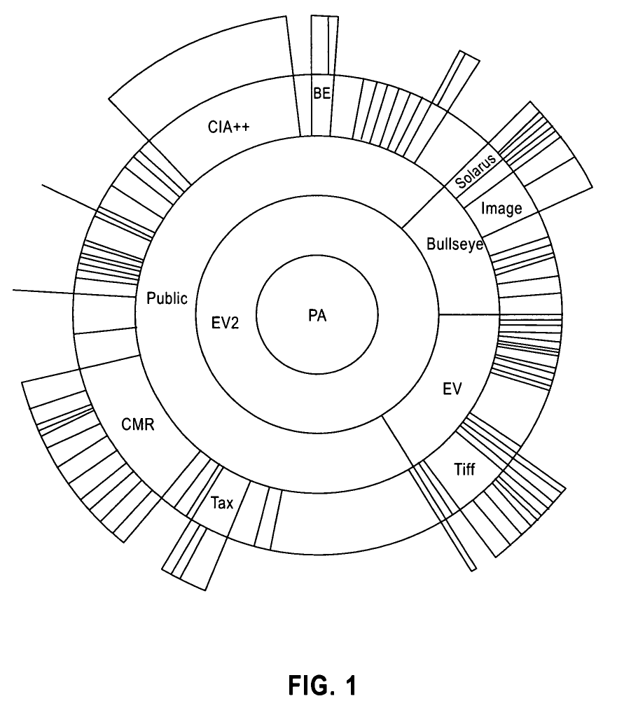

FIG. 2 is a conventional tree diagram for visualizing a company organization structure.

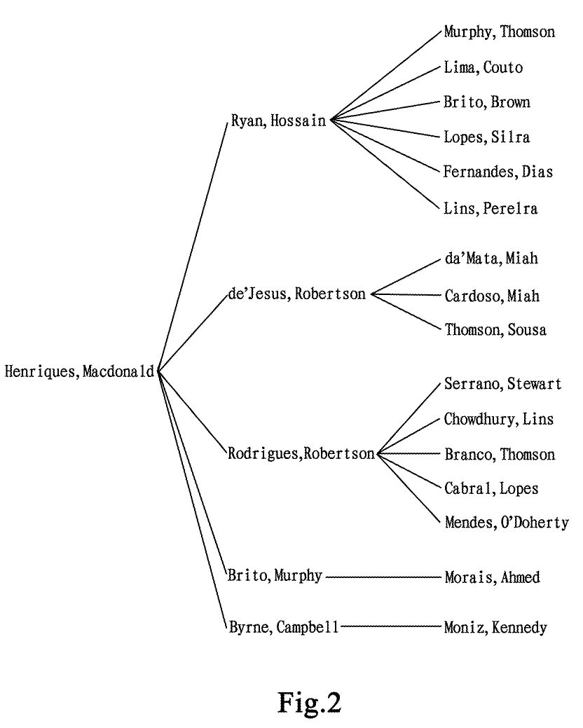

FIG. 3 is a conventional sunburst chart for visualizing a company organization structure.

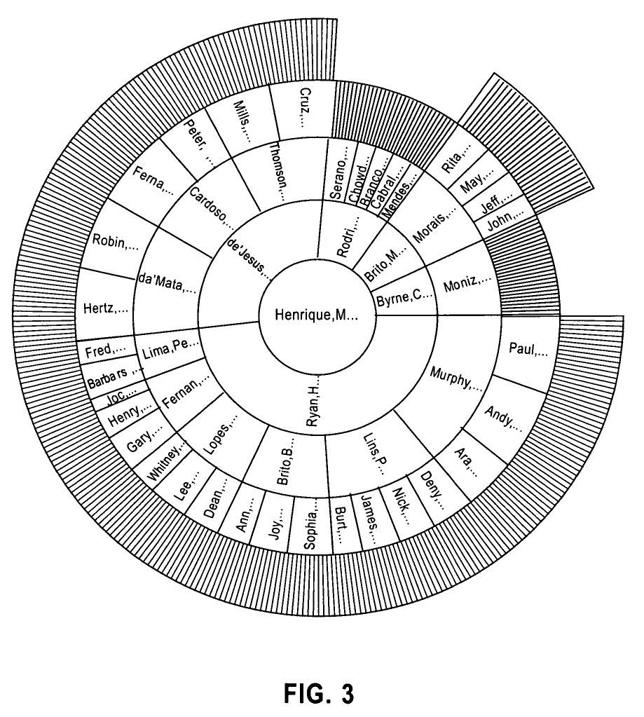

FIG. 4 is a flow chart of a method for visualizing hierarchy data with angular chart according to one embodiment of the present invention.

FIG. 5 is a schematic diagram for visualizing base levels of the hierarchy data in the embodiment of FIG. 4.

FIG. 6 is a flow chart of a method for visualizing hierarchy data with angular chart according to another embodiment of the present invention.

FIG. 7 is a schematic diagram for changing radius of the slice in the embodiment of FIG. 6.

FIG. 8 is a schematic diagram for changing radius of the slice in the embodiment of FIG. 6;

FIG. 9 is a schematic diagram for changing central angle of the slice in the embodiment of FIG. 6;

FIG. 10 is a schematic sunburst chart for visualizing the company organization structure according to the method of the embodiment of FIG. 6;

FIG. 11 is schematic sunburst chart for visualizing detailed information in the company organization structure according to the method of the embodiment of FIG. 6;

FIGS. 12A and 12B are schematic sunburst charts for visualizing further detailed information in the company organization structure according to the method of the embodiment of FIG. 6;

FIG. 13 is a schematic sunburst chart for visualizing detailed information in the company organization structure according to the method of the embodiment of FIG. 6;

FIG. 14 is a schematic sunburst chart for visualizing a portion of the company organization structure according to the method of the embodiment of FIG. 6;

FIGS. 15A, 15B and 15C are schematic diagrams of using a pie chart to visualize sales department report.

FIGS. 16A, 16B and 16C are schematic diagrams of using a ring chart to visualize both regional profit report and marketing spending.

FIG. 17 is a structural block diagram of an apparatus for visualizing hierarchy data with angular chart according to one embodiment of the present invention.

FIG. 18 is a structural block diagram of an apparatus for visualizing hierarchy data with angular chart according to another embodiment of the present invention.

FIG. 19 is a flow chart of an interaction method for angular chart visualization according to one embodiment of the present invention;

FIG. 20 is a structural block diagram of an interaction apparatus for angular chart visualization according to one embodiment of the present invention.

### DETAILED DESCRIPTION OF THE INVENTION

It is believed that the above-mentioned and other purposes, characteristics and advantages of the present invention would become more apparent through the detailed description of the embodiments of the present invention in conjunction with the drawings.

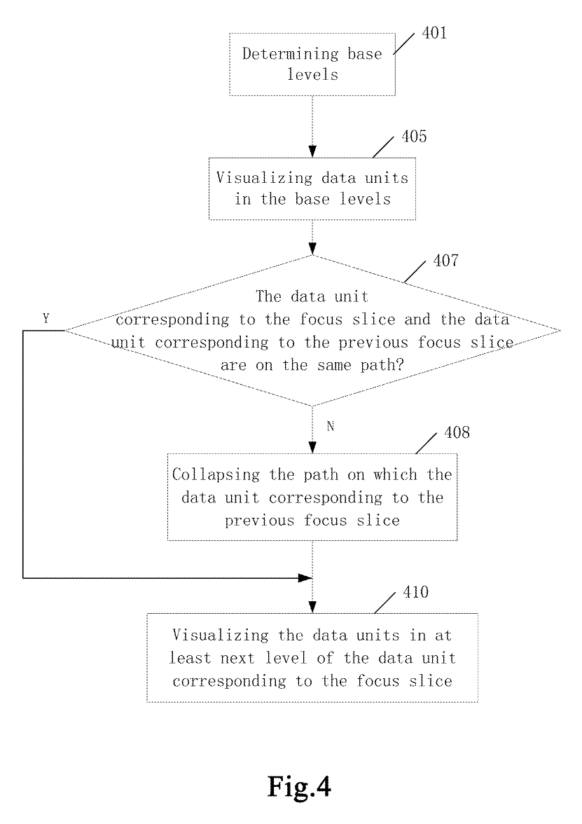

FIG. 4 shows a flow chart of a method for visualizing hierarchy data with an angular chart according to an embodiment of the present invention. The embodiment will be described in detail below in conjunction with the figure.

In this embodiment, in order to solve the problems in the prior art, the angular chart does not display the whole hierarchy data initially, but just displays some levels of the hierarchy data.

As shown in FIG. 4, at step 401, at least one of a plurality of levels of hierarchy data to be visualized is/are determined as base level(s). As mentioned above, the hierarchy data, such as company organization structure, file system and etc, comprise a plurality of levels and each level further comprises a plurality of data units. In this embodiment, the base levels can be determined by a user. Thus the user can determine the most important levels of the hierarchy data as the base levels and also determine the levels comprising an appropriate number of data units in the hierarchy data as the base levels. Moreover, the base level can also be determined by an appropriate algorithm based on distribution of the data units in the hierarchy data.

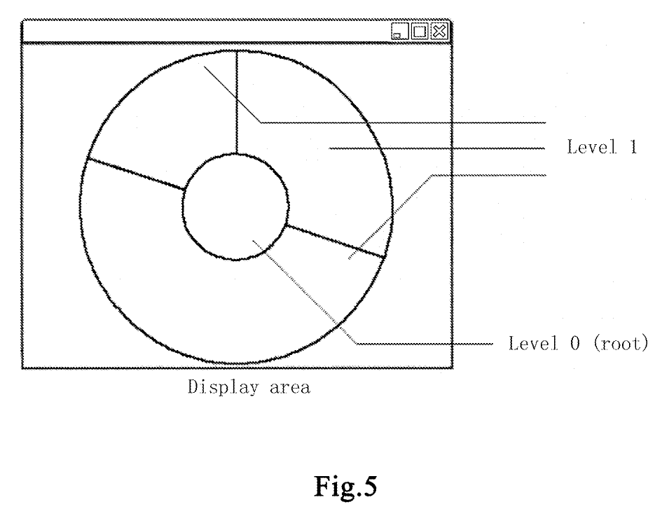

At step 405, after determining the base levels, the data units in the base levels are visualized with an angular chart, wherein each slice of the angular chart corresponds to the data unit in the hierarchy data. There exist many methods for visualizing data with an angular chart in the prior art and these methods are well-known to persons skilled in the art, so the descriptions thereof are omitted. FIG. 5 shows a schematic diagram for visualizing the base levels of the hierarchy data with the angular chart in the display area. In FIG. 5, there are two base levels.

If the user wants to know the structures and contents of the levels under the base levels of the hierarchy data, he/she can operate on the slice of the displayed angular chart. Then, at step 410, in response to the user's operation, the data units in at least a next level of the data unit corresponding to the slice (focus slice) on which the user operates in the hierarchy data are visualized. For example, if the user selects a certain slice of the angular chart, the data units in the next level corresponding to the focus slice are visualized in the angular chart. Thus, the user can customize the angular chart visualization and see the structure, content and context of the concerned level easily.

Furthermore, the user can change the focus slice to customize the different angular charts visualization. In this case, before performing the step 410, it is determined whether the data unit corresponding to the focus slice and the data unit corresponding to the previous focus slice are on the same path (step 407), i.e. whether the data unit corresponding to the current focus slice is the data unit in the next level of the data unit corresponding to the previous focus slice. If yes, step 410 will be performed. Otherwise, the path on which the data unit corresponding to the previous focus slice exists will be collapsed to the same level as that of the data unit corresponding to the current focus slice (step 408), and then step 410 is performed.

In this embodiment, the angular chart can be any one of a sunburst chart, a pie chart or a ring chart.

If the angular chart is a sunburst chart, all of the levels of the hierarchy data form concentric circles. The higher the level is, the closer to the circle center the level is, i.e. the data units in the lower level are outside those in the upper level. When the data units in the next level of the data unit corresponding to the focus slice are visualized, the data units in the next level are visualized in the outside of the data unit corresponding to the focus slice.

If the angular chart is the pie chart or ring chart, when the data units in the next level of the data unit corresponding to the focus slice are visualized, the data units in the next level are visualized within the data unit corresponding to the focus slice, which means that the data units in the next level cover those in the current level.

Moreover, if the angular chart is a ring chart and if the focus slice is not in the outmost ring of the ring chart, the ring containing the focus slice is moved to the outmost of the ring chart before performing step 410.

It can be seen from the above description that in the method for visualizing hierarchy data with an angular chart of this embodiment, only the data units in the base levels of the hierarchy data are visualized initially, and then the data units in the next level of the data unit corresponding to the focus slice are visualized according to the user's operation on the focus slice. Therefore, even if the hierarchy data has numerous levels and/or numerous data units, the data units in each level of the hierarchy data can be visualized hierarchically and clearly, thereby the problem that the angular chart looks tousled is overcome and the angular chart visualization can be customized based on the user's requirements.

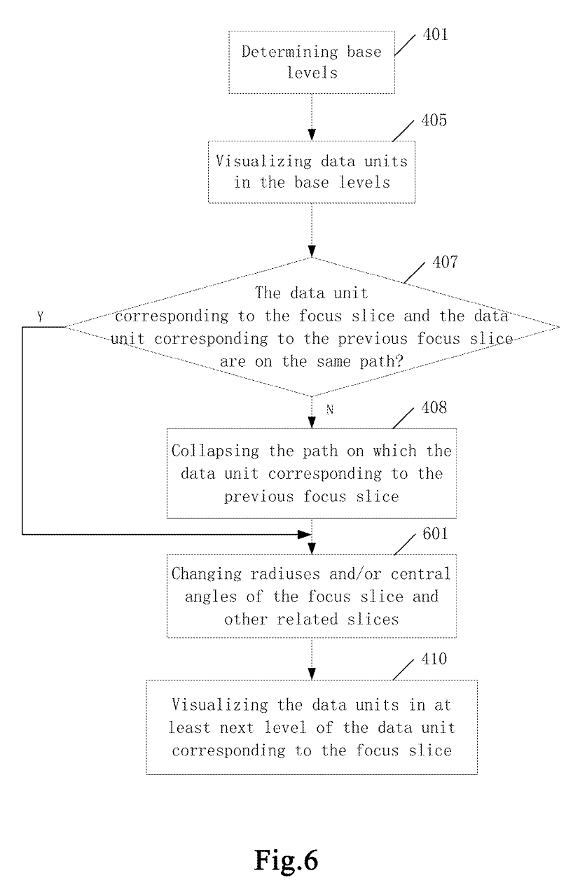

FIG. 6 shows a flow chart of the method for visualizing hierarchy data with an angular chart according to another embodiment of the present invention, wherein the same parts as those of the previous embodiment use the same reference numbers and their description are omitted properly. This embodiment will be described in detail as below in conjunction with FIG. 6.

As shown in FIG. 6, when the user operates on a certain slice of the angular chart, at step 601, the radius and/or central angle of at least one slice associated with the user's operation are changed, i.e. the radiuses and/or central angles of the focus slice and other related slices are changed.

Specifically, to change the radius of the slice can comprise increasing the radius of the focus slice; or reducing the radiuses of the slices of the data units (contexts) in the levels higher or equal to the level of the data unit corresponding to the focus slice, i.e. reducing the radiuses of the slices of the contexts of the data unit corresponding to the focus slice. Of course, the radius of the focus slice can be increased while the radiuses of the slices of the contexts are reduced.

To change the central angle can comprise enlarging the central angle of the focus slice, or enlarging the central angles of all slices on the path on which the focus slice exists.

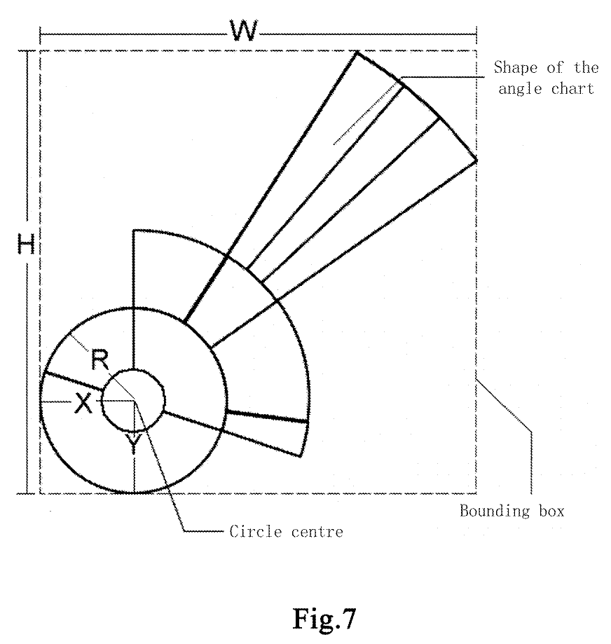

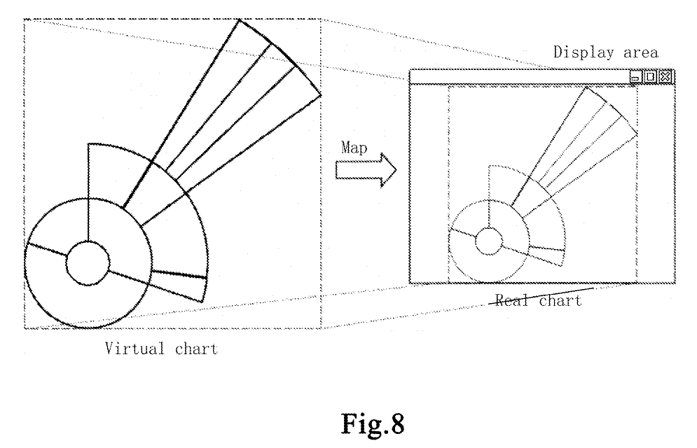

One embodiment of changing the radius of the slice of the angular chart is illustrated by FIGS. 7 and 8. It comprises 2 phases. The first stage is to determine the shape of the changed angular chart. This can be achieved by the following steps: creating a virtual chart with a pre-determined circle center position and radius; then calculating the bounding box of the virtual chart (i.e. the smallest rectangle containing the whole chart) as well as the circle center position and the radius of the virtual chart with respect to the bounding box; and finally recording the circle center position and the radius. FIG. 7 shows the shape, bounding box, circle center position and radius of the virtual chart.

The second phase is to map the virtual chart obtained in the first phase to the display area. This can be achieved by following steps including firstly determining the bounding box in the real display area then calculating the circle center and the radius in the real display area based on the recoded information of the virtual chart. In this way, the geometry information of the real angular chart can be retrieved easily. FIG. 8 schematically shows the process of the second phase.

Of course, persons skilled in the art can understand that other methods can be used to change the radius of the slice.

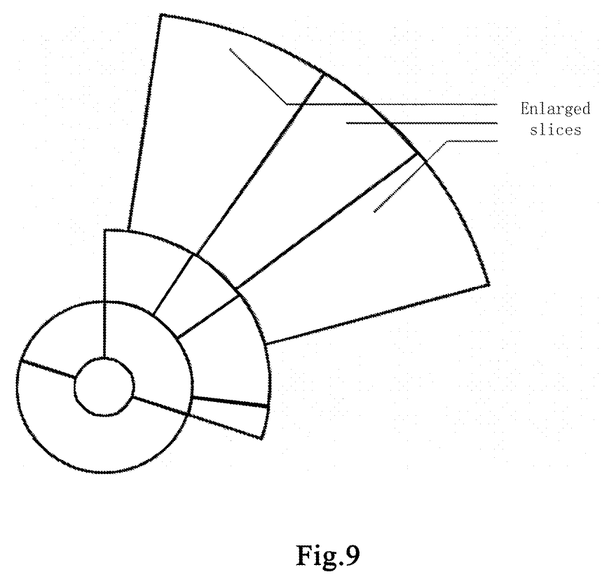

FIG. 9 shows a schematic diagram of an embodiment of changing the central angle of the slice. In the case that the hierarchy data comprises numerous data units, the central angles of some slices are very small. Such slices can be very difficult to distinguish, even if their radiuses are increased. So it is necessary to enlarge the central angle of the slice, for example 180°, so that the central angles of the sub-slices in the slice are also enlarged. This method of changing the central angle will break the context between the slice and its ancestor slices, but the users can view the structure and content of the slice clearly.

It can be seen from the above description that the method for visualizing hierarchy data with an angular chart according to the embodiment can visualize the structure and the content of the focus slice more clearly by increasing the area occupied by the focus slice.

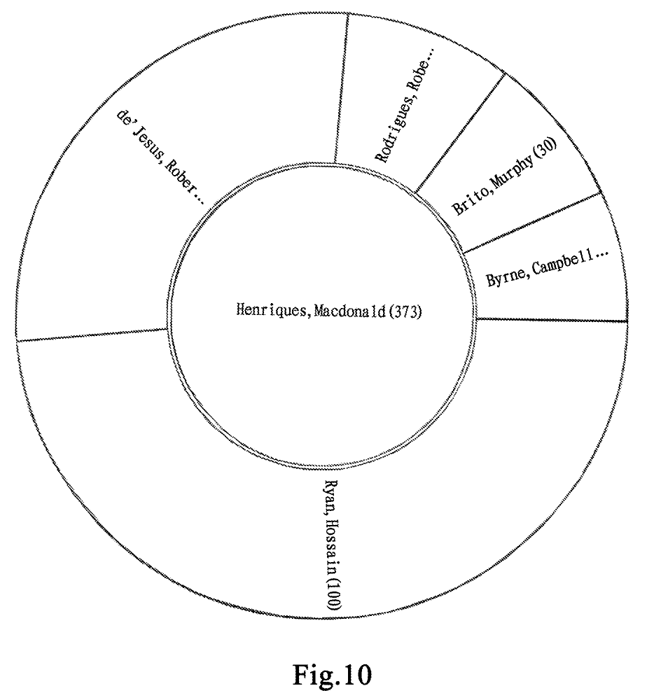

Next the methods of above two embodiments will be illustrated by an example. Assuming that the hierarchy data is a company organization structure and the angular chart is a sunburst chart, according to the organization structure, two levels are determined as the base levels, i.e. Level 1 and Level 2. FIG. 10 shows the base levels of the company organization structure. According to FIG. 10, the user can understand the main departments and their size in the company. Of course, the user can also determine other base levels based on the requirement.

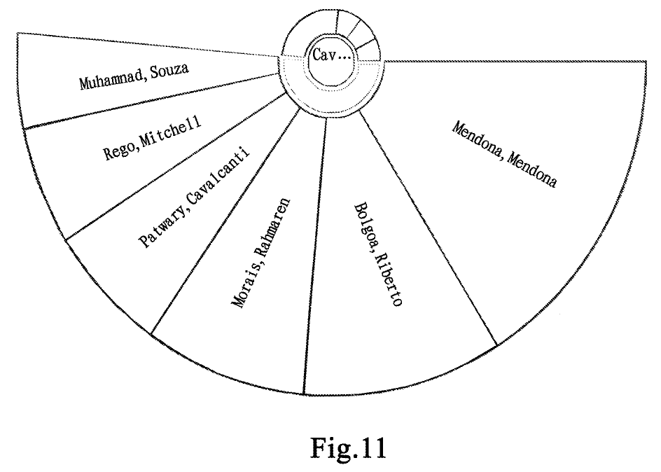

Then, if the user wants to learn more about the marketing department, he/she can click on the slice of “Ryan, Hossain (Chief Marketing Officer)” (selection operation). In response to the user's operation, the radius of the slice is increased and the radiuses of the base levels are reduced. Moreover, all sales directors under Ryan, Hossain (data units in the next level) are visualized in the slice with the increased radius, as shown in FIG. 11.

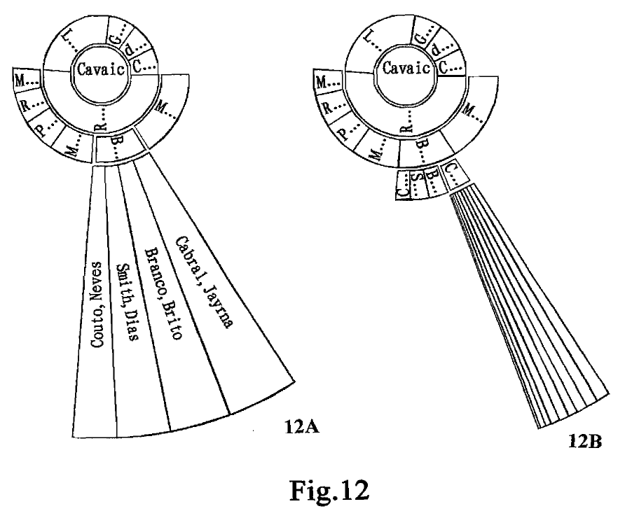

If the user wants to learn more about the further lower levels of the slice, he/she can click the concerned slices level by level. Through the above operations, the data units in the next level of the data unit corresponding to the concerned slice can be visualized, as shown in FIGS. 12A and 12B.

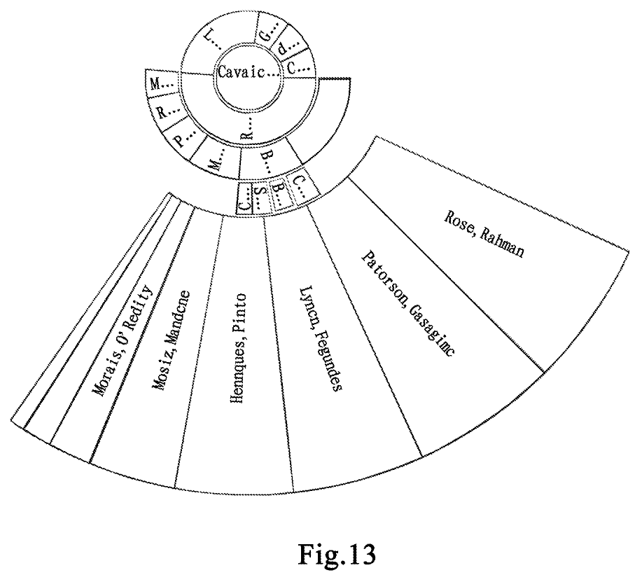

It can be seen from FIGS. 12A and 12B that the central angles of the slices of Level 5 are very small, thus they are difficult to be recognized and text cannot be easily written into the slices. In order to solve the problems, the central angles of the focus slice (Branco, Brito) as well as the central angles of the sub-slices in the next level (Level 5) can be enlarged to obtain clear views, as shown in FIG. 13.

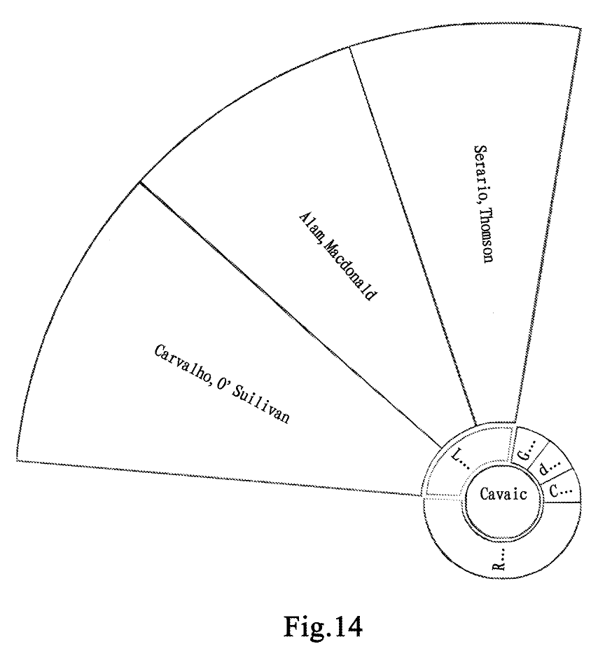

Furthermore, if the user wants to learn about the structures and contents of other slices, for example the slice of “de'Jesus, Robert”, the user can click on the slice (change operation). Because the current operated slice is not on the same path as that of the previous slice, the path on which the previous slice exists would be collapsed to the same level as that of the currently selected slice. Then, the above operations are performed on the current operated slice and the staff under “de'Jesus, Robert” (data units in the next level) are visualized, as shown in FIG. 14.

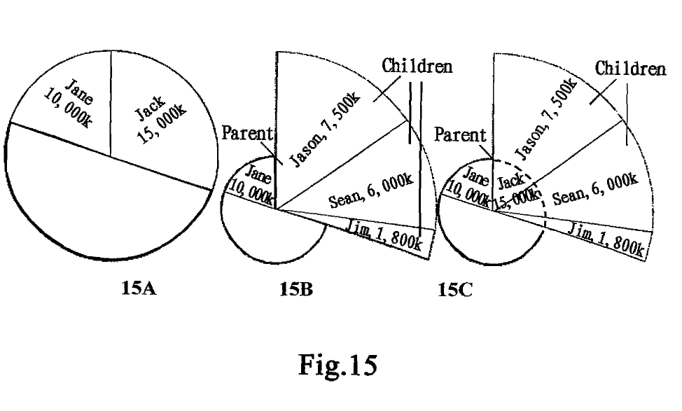

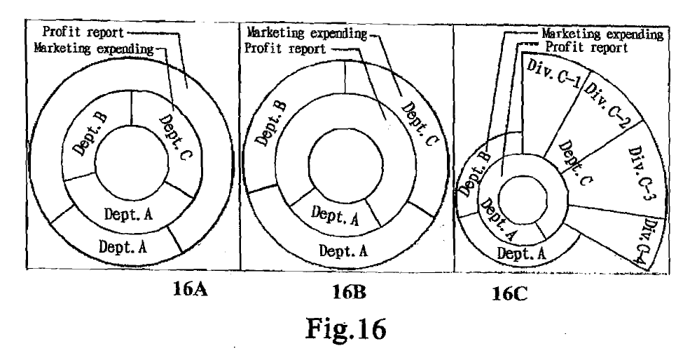

FIG. 15 is a set of schematic diagrams using a pie chart to visualize the sales department report. At first, the base levels are visualized with the pie chart, as shown in FIG. 16A. If the user wants to know the content of the slice of “Jack”, he/she clicks on the slice. In this way, the radius of the slice is increased and the radiuses of other slices are reduced, and data units in the next level of “Jack” are visualized in the slice of “Jack”, as shown in FIG. 15B. In FIG. 15B, the data unit of “Jack” is hidden. Of course, the data unit of “Jack” can also be presented in a dashed line or transparence, as shown in FIG. 15C.

In addition, FIG. 16 has a set of schematic diagrams using a ring chart to visualize regional profit report and marketing expending. Unlike the sunburst chart and pie chart, the ring chart can be used to represent multiple independent sequences of data distribution and each sequence is displayed within a ring. FIG. 16A shows the base levels of the regional profit report and marketing expending within two rings, wherein the regional profit report is in the outer ring and the marketing expending is in the inner ring. If the user clicks on a certain slice of the outer ring (the regional profit report), the operations are the same as those on the sunburst chart and pie chart. If the user clicks on a certain slice of the inner ring (the marketing expending), for example Dept. C, the inner ring containing the slice should be moved to the outmost, as shown in FIG. 16B. Thus, the marketing expending is in the outer ring, while the regional profit report is in the inner ring. And then, the radius of this slice is increased and the radiuses of the others are reduced, and the data in the next level of Dept. C is displayed in this slice, as shown in FIG. 16C.

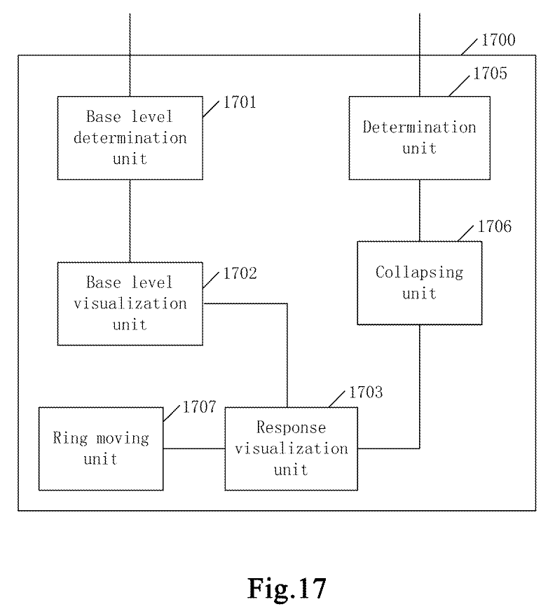

Under the same inventive concept, FIG. 17 shows a structural block diagram of an apparatus for visualizing hierarchy data with an angular chart according to one embodiment of the present invention. The embodiment will be described in detail below taken in conjunction with the figure.

As shown in FIG. 17, the apparatus 1700 for visualizing hierarchy data with an angular chart of this embodiment comprises: a base level determination unit 1701 for determining at least one of a plurality of levels of the hierarchy data as the base levels; a base level visualization unit 1702 for visualizing data units in the base levels with the angular chart, wherein each slice of the angular chart corresponds to the data unit in the hierarchy data; and a response visualization unit 1703 for, in response to user's operation on the slice of the angular chart, visualizing data units in at least one next level of the data unit corresponding to the slice (focus slice) on which the user operates.

As mentioned above, the hierarchy data comprises data units in a plurality of levels. In this embodiment, the base level determination unit 1701 can determine the base levels by appropriate algorithm based on the distribution of the data units in the hierarchy data. Also the base level determination unit 1701 can be selected by the user to determine the base levels. After the base levels of the hierarchy data are determined, the base level visualization unit 1702 visualizes the data units in the base levels with the angular chart. When the user operates on the slice of the angular chart, the response visualization unit 1703 visualizes the data units in at least a next level of the data unit corresponding to the focus slice.

The apparatus 1700 for visualizing hierarchy data with an angular chart of this embodiment further comprises a determination unit 1705 for determining whether the data unit corresponding to the focus slice and the data unit corresponding to the previous focus slice are on the same path and a collapsing unit 1706 for collapsing the path on which the data unit corresponding to the previous focus slice exists to the same level as that of the data unit corresponding to the focus slice, if the determination result of the determination unit 1705 is negative.

In this case, when the user operates on the slice of the angular chart, firstly the determination unit 1705 determines whether the data unit corresponding to the current focus slice is the data unit in the next level of the data unit corresponding to the previous focus slice; if yes, the response visualization unit 1703 visualizes the data units in the next level of the data unit corresponding to the current focus slice; otherwise, the collapsing unit 1706 collapses the path on which the data unit corresponding to the previous focus slice exists to the same level as that of the data unit corresponding to the focus slice, and then the response visualization unit 1703 visualizes the corresponding data units.

As described above, the angular chart can be any one of a sunburst chart, a pie chart or a ring chart.

If the angular chart is the sunburst chart, all levels of the hierarchy data form a concentric circle. The higher the level is, the closer to the circle center it is, i.e. the data units in the next level are outside the data units in the previous level. In this case, the response visualization unit 1703 visualizes the data units in the next level of the data unit corresponding to the focus slice in the outside of the data unit corresponding to the focus slice.

If the angular chart is a pie chart or ring chart, the response visualization unit 1703 visualizes the slices of the data units in the next level of the data unit corresponding to the focus slice by covering the data unit corresponding to the focus slice.

In addition, the apparatus 1700 for visualizing hierarchy data with an angular chart of this embodiment can further comprise a ring moving unit 1707 for, when the angular chart is the ring chart, moving the ring containing the focus slice to the outmost of the ring chart if the focus slice is not in the outmost ring of the ring chart.

The apparatus 1700 for visualizing hierarchy data with an angular chart of this embodiment and its components can be implemented by a hardware circuit such as Very Large Scale Integrated (VLSI) Circuit or gate array, semiconductors such as logic chips and transistors, a programmable hardware device such as a field programmable gate array, programmable logic device, software executing on various types of processors, and/or by a combination of above hardware circuit and software. The apparatus 1700 for visualizing hierarchy data with an angular chart of this embodiment can operationally perform the method for visualizing hierarchy data with an angular chart as shown in FIG. 4.

It can be seen from the above description that by using the apparatus for visualizing hierarchy data with an angular chart of this embodiment, only the data units in the base levels of the hierarchy data are visualized initially, and then the data units in the next level of the data unit corresponding to the focus slice are visualized based on the user's operation on the focus slice. Therefore, even if the hierarchy data has numerous levels and/or numerous data units, the data units in each level of the hierarchy data can be visualized hierarchically and clearly, whereby the problem that the angular chart looks tousled can be overcome and the angular chart visualization can be customized based on the user's requirement.

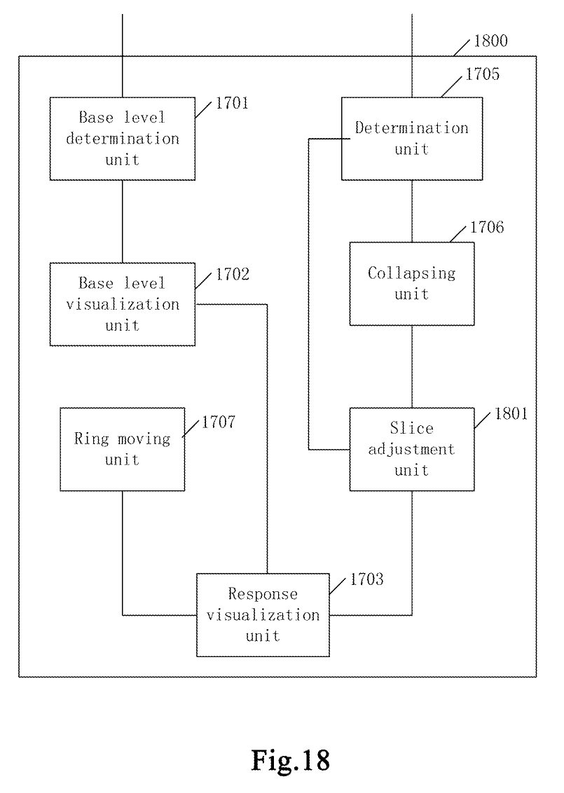

FIG. 18 is a structural block diagram of an apparatus 1800 for visualizing hierarchy data with an angular chart according to another embodiment of the present invention. In this embodiment, the same parts as those of the previous embodiment use the same reference numbers and their descriptions are omitted properly. This embodiment will be described below in conjunction with the figure.

Compared with the embodiment of FIG. 17, the apparatus 1800 for visualizing hierarchy data with an angular chart of this embodiment further comprises a slice adjustment unit 1801 for changing radius and/or central angle of at least one slice associated with the user's operation.

Specifically, the slice adjustment unit 1801 can include a radius adjustment unit for increasing the radius of the focus slice, or reducing the radiuses of the slices of the data units (contexts) in the level higher or equal to the level of the data unit corresponding to the focus slice, or both increasing the radius of the focus slice and reducing the radiuses of the slices of the contexts of the data units not corresponding to the focus slice.

In addition, the slice adjustment unit 1801 further comprises a central angle adjustment unit for enlarging the central angles of the slices of the data units in the next level of the data unit corresponding to the focus slice, or enlarging the central angles of all slices on the path on which the focus slice exists.

The specific implementation of changing the radiuses and/or central angles of the slices by the slice adjustment unit 1801 can refer to the above embodiments and its description is omitted here.

After the slice adjustment unit 1801 has changed the radiuses and/or the central angles of the related slices, the response visualization unit 1703 visualizes the data units in the next level of the data unit corresponding to the current focus slice.

The apparatus 1800 for visualizing hierarchy data with an angular chart of this embodiment and its components can be implemented by hardware circuit such as Very Large Scale Integrated Circuit or gate array, semiconductor such as logic chips and transistors, programmable hardware device such as field programmable gate array, programmable logic device, software executing on various types of processors, and/or by a combination of above hardware circuit and software. The apparatus 1800 for visualizing hierarchy data with an angular chart of this embodiment can operationally perform the method for visualizing hierarchy data with angular chart as shown in FIG. 6.

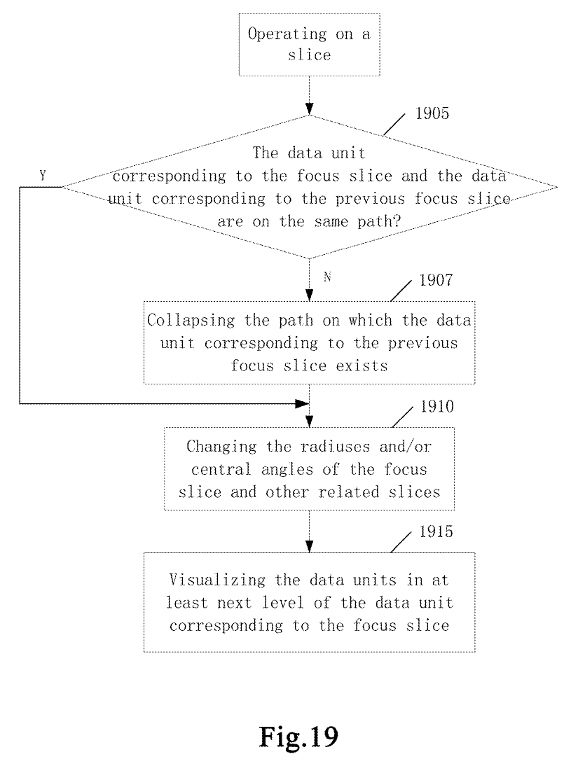

FIG. 19 shows a flow chart of an interaction method for angular chart visualization according to one embodiment of the present invention, wherein the angular chart displays hierarchy data comprising a plurality of levels and each slice of the angular chart corresponds to a data unit in the hierarchy data.

As shown in FIG. 19, at step 1910, in response to user's operation on the slice of the angular chart, the radius and/or the central angle of at least one slice associated with the user's operation are changed.

Specifically, to change the radius of the related slice can comprise increasing the radius of the slice on which the user operates (i.e., the focus slice), or reducing the radiuses of the slices of the data units (contexts) in the level higher or equal to the level of the data unit corresponding to the focus slice, or both increasing the radius of the focus slice and reducing the radiuses of the slices of the contexts of the data unit corresponding to the focus slice.

In addition, changing the central angle of the related slice can be implemented by enlarging the central angle of the focus slice or enlarging the central angles of all slices on the path on which the focus slice exists.

The specific implementation of changing the radiuses and central angles of the slices is described above with reference to the above embodiments and its description is omitted here.

Further, in this embodiment, when the user operates on the slice of the angular chart, at step 1905, it is determined whether the data unit corresponding to the focus slice and the data unit corresponding to the previous focus slice are on the same path, i.e. whether the data unit corresponding to the focus slice is the sub-data unit of the data unit corresponding to the previous focus slice. If yes, step 1910 is performed. Otherwise, if both data units are not on the same path, at step 1907, the path on which the data unit corresponding to the previous focus slice exists is collapsed to the same level as that of the data unit corresponding to the focus slice. Then, step 1910 is performed.

In addition, the angular chart can only display the base levels of the hierarchy data. In this case, after performing step 1910, the data units in the next level of the data unit corresponding to the focus slice are visualized (step 1915).

In this embodiment, the angular chart can be any one of a sunburst chart, a pie chart or a ring chart.

If the angular chart is a sunburst chart, when the data units in the next level of the data unit corresponding to the focus slice are visualized, the data units in the next level are visualized in the outside of the data unit corresponding to the focus slice.

If the angular chart is a pie chart or ring chart, when the data units in the next level of the data unit corresponding to the focus slice are visualized, the data units in the next level are visualized within the data unit corresponding to the focus slice, i.e. the data units in the next level cover the data unit in the current level.

Moreover, in the case that the angular chart is a ring chart, if the focus slice is not in the outmost ring of the ring chart, before performing step 1910, the ring containing the focus slice is moved to the outmost of the ring chart.

It can be seen from above description that by using the interaction method for angular chart visualization of this embodiment, the user can customize the angular chart visualization. The user can view the structure and content of the concerned slice based on his/her requirements, and the area occupied by the focus slice can be increased so that the structure and content of the focus slice can be displayed more clearly. Moreover, the interaction method for angular chart visualization of this embodiment can interactively visualize the data units in each level under the base levels according to the user's operation, in the case that the angular chart only displays the base levels of the hierarchy data initially. Therefore, even if the hierarchy data has numerous levels and/or data units, the data units in each level of the hierarchy data can be visualized hierarchically and clearly, thereby overcoming the problem that the angular chart looks tousled.

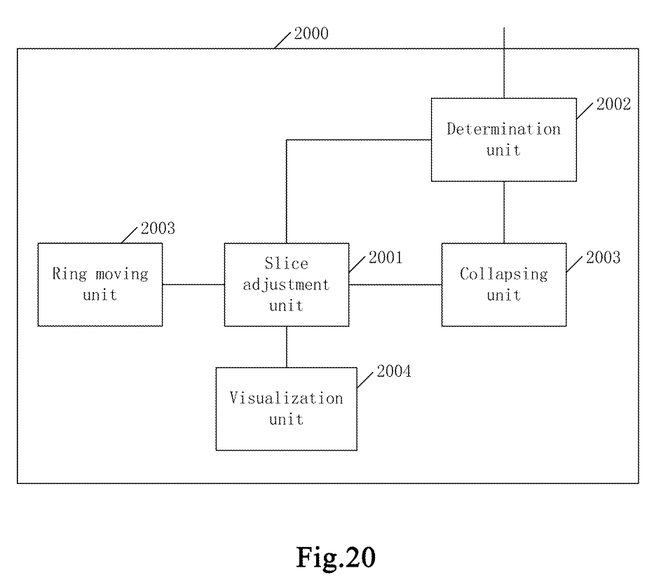

Under the same inventive concept, FIG. 20 shows a structural block diagram of an interaction apparatus for angular chart visualization according to one embodiment of the present invention, wherein the angular chart displays hierarchy data comprising a plurality of levels and each slice of the angular chart corresponds to a data unit in the hierarchy data. This embodiment will be described in detail below in conjunction with the drawing.

As shown in FIG. 20, the interaction apparatus 2000 for angular chart visualization of this embodiment comprises a slice adjustment unit 2001 for, in response to user's operation on the slice of the angular chart, changing radius and/or central angle of at least one slice associated with the user's operation.

In this embodiment, when the user operates on the slice of the angular chart, the slice adjustment unit 2001 changes the radius and/or central angle of the related slice of the angular chart based on the user's operation.

Specifically, the slice adjustment unit 2001 can comprise a radius adjustment unit for increasing the radius of the focus slice, or reducing the radiuses of the slices of the data units (contexts) in the level higher or equal to the level of the data unit corresponding to the focus slice, or both increasing the radius of the focus slice and reducing the radiuses of the slices of the contexts of the data unit corresponding to the focus slice.

In addition, the slice adjustment unit 2002 further comprises a central angle adjustment unit for enlarging the central angle of the focus slice, or enlarging the central angles of all the slices on the path on which the focus slice exists.

The specific implementation of changing the radius and central angle of the related slice by the slice adjustment unit 2002 can refer to the above embodiments and its description is omitted here.

Further, the interaction apparatus 2000 for angular chart visualization of this embodiment can comprises: a determination unit 2002 for determining whether the data unit corresponding to the focus slice and the data unit corresponding to the previous focus slice are on the same path; and a collapsing unit 2003 for collapsing the path on which the data unit corresponding to the previous focus slice exists to the same level as that of the data unit corresponding to the focus slice, if the determination result of the determination unit 2002 is negative.

In this embodiment, when the user operates on a certain slice of the angular chart, the determination unit 2002 determines whether the data unit corresponding to the focus slice is the data unit in the next level of the data unit corresponding to the previous focus slice. If yes, the slice adjustment unit 2001 adjusts the focus slice and the related slices correspondingly. Otherwise, the collapsing unit 2003 collapses the path on which the data unit corresponding to the previous focus slice exists to the same level as that of the data unit corresponding to the focus slice, and then the slice adjustment unit 2001 adjusts the focus slice and the related slices.

In addition, in the case that the angular chart only displays the base levels of the hierarchy data, the interaction apparatus 2000 for angular chart visualization of this embodiment further comprises a visualization unit 2004 for visualizing the data units in the next level of the data unit corresponding to the focus slice.

As described above, the angular chart can be any one of a sunburst chart, pie chart or ring chart.

If the angular chart is a sunburst chart, the visualization unit 2004 visualizes the data units in the next level of the data unit corresponding to the focus slice at the outside of the data unit corresponding to the focus slice.

If the angular chart is a pie chart or ring chart, the visualization unit 2004 visualizes the slices of the data units in the next level of the data unit corresponding to the focus slice as covering the focus slice.

In addition, the interaction apparatus 2000 for angular chart visualization of this embodiment further comprises a ring moving unit for, when the angular chart is a ring chart, moving the ring containing the focus slice to the outmost of the ring chart if the focus slice is not in the outmost ring of the ring chart. Then, the focus slice and the related slices are adjusted by the slice adjustment unit 2001.

The interaction apparatus 2000 for angular chart visualization of this embodiment and its components can be implemented by one or more hardware circuit such as Very Large Scale Integrated Circuit or gate array, semiconductors such as logic chips and transistors, programmable hardware device such as a field programmable gate array, programmable logic device, software executing on various types of processors, and/or by a combination of above hardware circuit and software. The interaction apparatus 2000 for angular chart visualization of this embodiment can operationally perform the method for angular chart visualization as shown in FIG. 19.

Although a method and apparatus for visualizing hierarchy data with an angular chart and an interaction method and apparatus for angular chart visualization of the present invention are described in detail for the specified embodiments in the above, the present invention is not limited as above. It should be understood for persons skilled in the art that the above embodiments may be varied, replaced or modified without departing from the spirit and the scope of the present invention.

1. A method for visualizing hierarchy data with an angular chart, the hierarchy data comprising a plurality of levels, which method comprises the steps of:
determining at least one of the plurality of levels of the hierarchy data as base levels;
visualizing data units in the base levels with the angular chart, wherein each slice of the angular chart corresponds to the data unit in the hierarchy data; and
in response to user selection of a slice of the angular chart, visualizing data units in at least a next level of the data unit corresponding to the currently selected slice in the hierarchy data.

2. The method for visualizing hierarchy data with an angular chart according to claim 1, further comprising:
determining whether the data unit corresponding to the currently selected slice and a data unit corresponding to the selected slice are on the same path; and
if the both data units are not on the same path, collapsing the path on which the data unit corresponding to the selected slice exists to the same level as that of the data unit corresponding to the currently selected slice.

3. The method for visualizing hierarchy data with an angular chart according to claim 1, further comprising changing at least one of radius and central angle of at least one slice associated with the user selection.

4. The method for visualizing hierarchy data with an angular chart according to claim 3, wherein the step of changing radius of at least one slice associated with the user selection comprises at least one of increasing the radius of the currently selected slice and reducing the radiuses of the slices of the data units in the level higher or equal to the level of the data unit corresponding to the currently selected slice;
and wherein the step of changing central angle of at least one slice associated with the user selection comprises one of enlarging the central angle of the currently selected slice and enlarging the central angles of all slices on the path on which the currently selected slice exists.

5. The method for visualizing hierarchy data with an angular chart according to claim 1, wherein when the angular chart is one of a pie chart or a ring chart, the step of visualizing data units in at least next level of the data unit corresponding to the currently selected slice in the hierarchy data comprises visualizing the data units in the at least next level of the data unit responding to the currently selected slice in the hierarchy data by covering the data unit corresponding to the currently selected slice in the hierarchy data.

6. The method for visualizing hierarchy data with an angular chart according to claim 1, further comprising, when the angular chart is a ring chart, if the currently selected slice is not in the outmost ring of the ring chart, moving the ring containing the currently selected slice to the outmost of the ring chart.

7. An apparatus for visualizing hierarchy data with an angular chart, the hierarchy data comprising a plurality of levels, which apparatus comprises:
a base level determination unit for determining at least one of the plurality of levels of the hierarchy data as base levels;
a base level visualization unit for visualizing data units in the base levels with the angular chart, wherein each slice of the angular chart corresponds to the data unit in the hierarchy data; and
a response visualization unit for, in response to user selection of on the slice of the angular chart, visualizing data units in at least next level of the data unit corresponding to the currently selected slice in the hierarchy data.

8. The apparatus for visualizing hierarchy data with an angular chart according to claim 7, further comprising:
a determination unit for determining whether the data unit corresponding to the currently selected slice and the data unit corresponding to the selected slice are on the same path; and
a collapsing unit for collapsing the path on which the data unit corresponding to the selected slice exists to the same level as that of the data unit corresponding to the currently selected slice, if the determination result of the determination unit is negative.

9. The apparatus for visualizing hierarchy data with an angular chart according to claim 7, further comprising a slice adjustment unit for changing at least one of radius and central angle of at least one slice associated with the user selection.

10. The apparatus for visualizing hierarchy data with an angular chart according to claim 9, wherein the slice adjustment unit comprises:
a radius adjustment unit for at least one of increasing the radius of the currently selected slice and reducing the radiuses of the slices of the data units in the level higher or equal to the level of the data unit corresponding to the currently selected slice; and
a central angle adjustment unit for enlarging at least one of the central angle of the currently selected slice and enlarging the central angles of all slices on the path on which the currently selected slice exists.

11. An interaction method for angular chart visualization, wherein an angular chart displays hierarchy data comprising a plurality of levels and each slice of the angular chart corresponds to a data unit in the hierarchy data, which interaction method comprises:
in response to user selection of a slice of the angular chart, changing at least one of the radius and central angle of at least one slice associated with the user selection.

12. The interaction method for angular chart visualization according to claim 11, wherein the step of changing radius of at least one slice associated with the user selection comprises at least one of increasing the radius of a currently selected slice and reducing the radiuses of the slices of the data units in the level higher than or equal to the level of the data unit corresponding to the currently selected slice;
and wherein the step of changing central angle of at least one slice associated with the user's operation comprises at least one of enlarging the central angle of the currently selected slice and enlarging the central angles of all slices on the path on which the currently selected slice exists.

13. The interaction method for angular chart visualization according to claim 11 further comprising:
determining whether the data unit corresponding to the currently selected slice and the data unit corresponding to the previously selected slice are on the same path;
if the both data units are not on the same path, collapsing the path on which the data unit corresponding to the previously selected slice exists to the same level as that of the data unit corresponding to the currently selected slice.

14. The interaction method for angular chart visualization according to claim 11 wherein the angular chart only displays the base level of the hierarchy data;
and wherein the interaction method further comprises visualizing the data units in at least next level of the data unit corresponding to the currently selected slice in the hierarchy data.

15. The interaction method for angular chart visualization according to claim 11, wherein in case that the angular chart is a pie chart or a ring chart, the step of visualizing the data units in at least next level of the data unit corresponding to the currently selected slice in the hierarchy data comprises: visualizing the data units in the at least next level of the data unit corresponding to the currently selected slice in the hierarchy data in manner of covering the data unit corresponding to the currently selected slice in the hierarchy data.

16. The interaction method for angular chart visualization according to claim 11, further comprising in case that the angular chart is a ring chart, if the currently selected slice is not in the outmost ring of the ring chart, moving the ring containing the currently selected slice to the outmost of the ring chart.

17. An interaction apparatus for angular chart visualization, wherein an angular chart displays hierarchy data comprising a plurality of levels and each slice of the angular chart corresponds to a data unit in the hierarchy data, which interaction apparatus comprises:
a slice adjustment unit for, in response to user selection on the slice of the angular chart, changing at least one of radius and central angle of at least one slice associated with the user selection.

18. The interaction apparatus for angular chart visualization according to claim 17, wherein the slice adjustment unit comprises at least one of:
a radius adjustment unit for at least one of increasing the radius of the selected slice and reducing the radiuses of the slices of the data units in the level higher or equal to the level of the data unit corresponding to the selected slice; and
a central angle adjustment unit for enlarging at least one of the central angle of the selected slice and the central angles of all slices on the path on which the selected slice exists.

19. The interaction apparatus for angular chart visualization according to claim 17, further comprising:
a determination unit for determining whether the data unit corresponding to the currently selected slice and the data unit corresponding to the previously selected slice are on the same path; and
a collapsing unit for collapsing the path on which the data unit corresponding to the previously selected slice exists to the same level as that of the data unit corresponding to the currently selected slice, if the determination result of the determination unit is negative.

20. The interaction apparatus for angular chart visualization according to claim 17, wherein the angular chart only displays the base levels of the hierarchy data;
and wherein the interaction apparatus further comprises a visualization unit for visualizing the data units in at least next level of the data unit corresponding to the currently selected slice in the hierarchy data.
